(19) United States
(12) Patent Application Publication
(10) Pub. No.: US 2023/0242154 A1
(43) Pub. Date: Aug. 3, 2023

(54) METHODS AND SYSTEMS FOR COLLISION MITIGATION

(71) Applicants: Sony Europe B.V., Surrey (GB); Sony Group Corporation, Tokyo (JP)

(72) Inventor: Renaud DIFRANCESCO, Basingstoke (GB)

(21) Appl. No.: 18/009,717

(22) PCT Filed: Jun. 29, 2021
(86) PCT No.: PCT/GB2021/051652

§ 371 Date: Dec. 10, 2022

(30) Foreign Application Priority Data
Jul. 3, 2020 (GB) 2010273.7

(51) Int. Cl. B60W 60/00; B60W 30/085; B60W 30/095; B60W 10/18; B60W 10/20; B60R 21/36

(52) U.S. Cl. CPC B60W 60/0017; B60W 30/085; B60W 30/0953; B60W 30/0956; B60W 10/18; B60W 10/20; B60R 21/36; B60W 2554/40

(57) ABSTRACT

A method of operating a vehicle is provided. The method comprises by a control circuitry of the vehicle in combination with one or more sensors of the vehicle, that a vulnerable subject is travelling on a path which intersects with a path on which the vehicle is travelling, determining, by the control circuitry, that a collision between the vehicle and the vulnerable subject is likely, predicting, by the control circuitry, a force of the collision, selecting, by the control circuitry in accordance with the predicted force of the collision, one of a plurality of models each defining an operation of the vehicle in response to determining that the vehicle is unable to avoid the collision, wherein the selected model is selected on the basis that the control circuitry determines it to result in a least amount of injury for the vulnerable subject from among the plurality of models, and controlling, by the control circuitry, one or more functions of the vehicle in accordance with the selected model.

### BACKGROUND

### Field of Disclosure

The present disclosure relates generally to the operation of a vehicle when it is detected that a collision between the vehicle and a vulnerable road user seems unavoidable unless emergency action succeeds, and specifically to effectuating operation of the vehicle such that a result of the collision is mitigated should the collision happen in spite of an avoidance intent.

The present application claims the Paris Convention priority from United Kingdom patent application number GB 2010273.7, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

With increased use and automatisation of motor and electric vehicles, there is an increased requirement for improving pedestrian (or other non-vehicular or vulnerable road users) and vehicle occupant safety. In recent years, there has been development of intelligent motor vehicles with advanced pedestrian safety mechanisms such as Automated Emergency Braking (AEB). With the aim of improving pedestrian and driver/vehicle occupant safety, there have been attempts for vehicles to communicate with pedestrians, cyclists and other vehicles with the development of Vehicle to Everything (V2X) and Vehicle to Pedestrian (V2P) technologies which may be Wireless Local Area Network (WLAN) based or cellular based.

In some cases however, due to factors such as vehicle speed, sudden changes in pedestrian, cyclist or other lighter road user (i.e. a road user lighter than the vehicle) trajectory, or view-obstructing objects, it is not possible to avoid collisions with pedestrians or other non-vehicular road users. In such cases, the best course of action for an intelligent motor vehicle to take is one which mitigates harm and damage (to both the vulnerable subject and the vehicle) to as great a degree as possible.

Embodiments of the present disclosure provide solutions for vehicles to take autonomous decisions that result in a least amount of injury for a non-vehicular road user in such cases.

SUMMARY OF THE DISCLOSURE

The present disclosure can help address or mitigate at least some of the issues discussed above.

Embodiments of the present disclosure can provide a method of operating a vehicle. The method comprises by a control unit of the vehicle in combination with one or more sensors of the vehicle, that a vulnerable subject is travelling on a path which intersects with a path on which the vehicle is travelling, determining, by the control unit, that a collision between the vehicle and the vulnerable subject is likely, predicting, by the control unit, a force of the collision, selecting, by the control unit in accordance with the predicted force of the collision, one of a plurality of models each defining an operation of the vehicle in response to determining that the vehicle is unable to avoid the collision, wherein the selected model is selected on the basis that the control unit determines it to result in a least amount of injury for the vulnerable subject from among the plurality of models, and controlling, by the control unit, one or more functions of the vehicle in accordance with the selected model.

Embodiments of the present disclosure, which further relate to a system for use in a vehicle, can be used to mitigate harm or injury caused to a vulnerable road user (for example a pedestrian or an animal) and/or to the vehicle itself as a consequence of an otherwise unavoidable collision.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 illustrates an example of a vehicle in accordance with embodiments of the present disclosure;

FIG. 2 shows an example of a vehicle apparatus in accordance with embodiments of the present disclosure;

FIG. 3 shows an example of a control unit in accordance with embodiments of the present disclosure;

FIG. 4 illustrates a first example of operation of a vehicle in accordance with embodiments of the present disclosure;

FIG. 5 illustrates a second example of operation of a vehicle where an unavoidable collision between the vehicle and a pedestrian has been detected in accordance with embodiments of the present disclosure;

FIG. 6 illustrates a third example of operation of a vehicle where functions are performed to mitigate the collision in accordance with embodiments of the present disclosure;

FIG. 7A illustrates a fourth example of operation of a vehicle where functions are performed to mitigate a collision between the vehicle and an animal in accordance with embodiments of the present disclosure;

FIG. 7B illustrates a fifth example of operation of a vehicle where functions are performed to mitigate a collision between the vehicle and a cyclist in accordance with embodiments of the present disclosure;

FIG. 7C illustrates a sixth example of operation of a vehicle where functions are performed to mitigate a collision between the vehicle and a wheelchair user in accordance with embodiments of the present disclosure;

FIG. 7D illustrates a seventh example of operation of a vehicle where functions are performed to mitigate a collision between the vehicle and a person operating a scooter in accordance with embodiments of the present disclosure;

FIG. 7E illustrates a eighth example of operation of a vehicle where functions are performed to mitigate a collision between the vehicle and a user of a mobility scooter in accordance with embodiments of the present disclosure;

FIG. 7F illustrates a ninth example of operation of a vehicle where functions are performed to mitigate a collision between the vehicle and a pushchair in accordance with embodiments of the present disclosure;

FIG. 8 illustrates a tenth example of operation of a vehicle where functions are performed to avoid a second collision between the pedestrian and a second vehicle in accordance with embodiments of the present disclosure;

FIG. 9 shows a first example configuration of external airbags on a vehicle in accordance with embodiments of the present disclosure;

FIG. 10 shows a second example configuration of external airbags on a vehicle in accordance with embodiments of the present disclosure;

FIG. 11 illustrates an example of a model selection unit in accordance with embodiments of the present disclosure; and

FIG. 12 illustrates a method flow diagram in accordance with embodiments of the present disclosure.

### DETAILED DESCRIPTION OF THE EMBODIMENTS

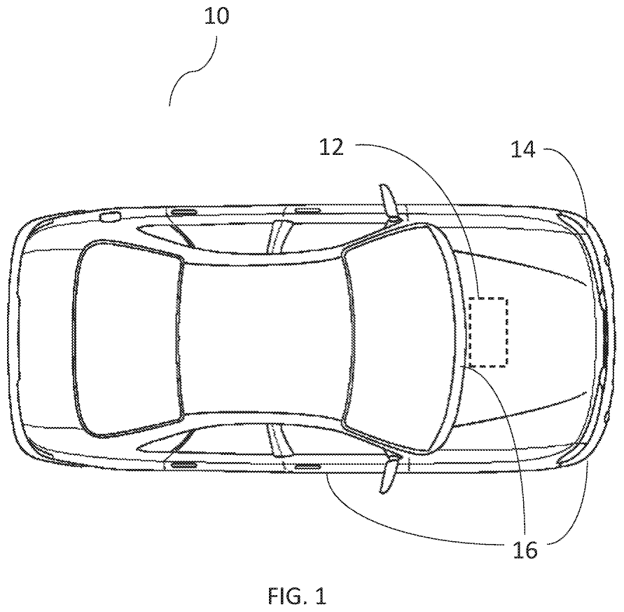

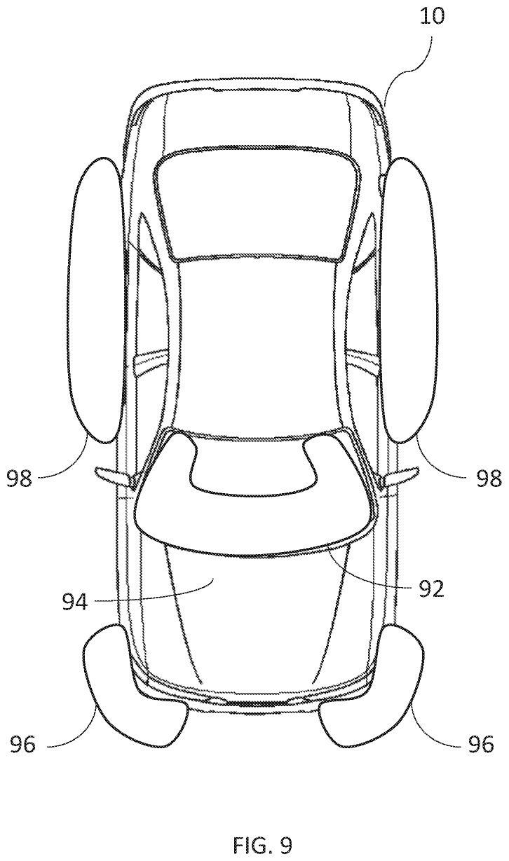

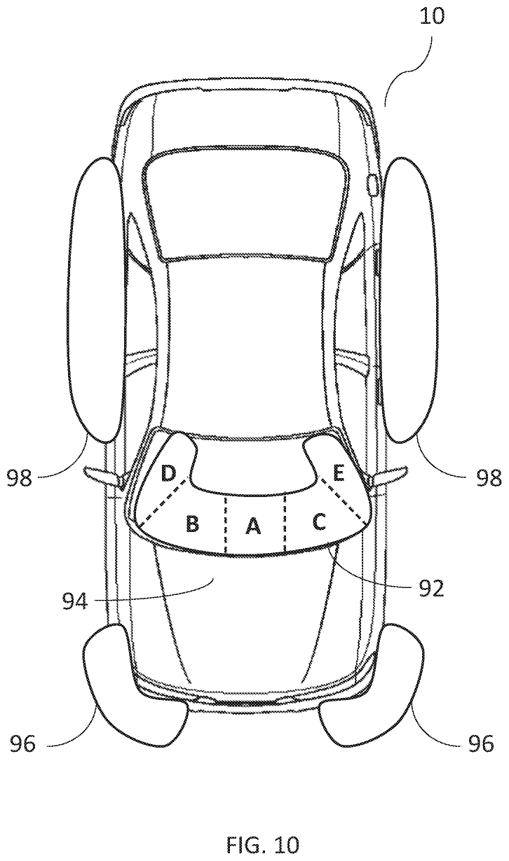

FIG. 1 shows an example of a vehicle 10 according to some embodiments of the present disclosure. The vehicle comprises vehicle apparatus 12, one or more sensors 14, and one or more external airbags 16. The vehicle apparatus 12 may comprise an on-board computer or the like, which may be located under the bonnet as shown in FIG. 1, or alternatively at the base of the windscreen, or in the passenger footwell or anywhere else in the vehicle from which it can perform its function. The sensors 14 may be any type of sensor capable of detecting information regarding a region surrounding the vehicle or relating to operation of the vehicle itself. It would of course be appreciated by those skilled in the art that a vehicle 10 comprises a large number of sensors 14 of various types configured for various functions. The external airbags 16 may be located at various points around the exterior of the vehicle 10, most typically at the base of the windscreen from where an airbag can be deployed to cushion the impact of a pedestrian or animal or the like being struck by the vehicle 10. External airbags 16 may also be located at other points around the exterior of the vehicle 10, for example at the front corners or along the sides, and may be used to cushion the impact of a pedestrian or animal or the like being struck by the vehicle 10 or mitigate the damage caused by a collision between the vehicle 10 and other vehicles. FIGS. 9 and 10 show example configurations of the external airbags 16, and are described in further detail below in accordance with example embodiments of the present disclosure.

It should be appreciated by those skilled in the art that the arrangement of vehicle apparatus 12, sensors 14, and external airbags 16 as shown in FIG. 1 is only one possible arrangement for a vehicle 10, and that any other conceivable arrangement is possible in accordance with embodiments of the present disclosure. Specifically, the number and location of each of the vehicle apparatus 12, sensors 14, and external airbags 16 may be varied in a number of ways without detracting from the scope of embodiments of the present disclosure. Although vehicle 10 is shown in FIG. 1 to be a car, those skilled in the art would appreciate that the term “vehicle” and embodiments of the present disclosure could equally be applied to any road vehicle, including but not limited to a motorcycle, a van, a truck, a lorry, a bus, off-road vehicles currently using the road, including agricultural vehicles in their road or field operation, or a non-motorised road vehicle. Furthermore, where the term “road” is used herein as the location of operation of collision detection techniques in accordance with the present disclosure, those skilled in the art would appreciate that such techniques may be effected at any suitable location, whether that is on a road, on a path, in car parks, fields, or the like.

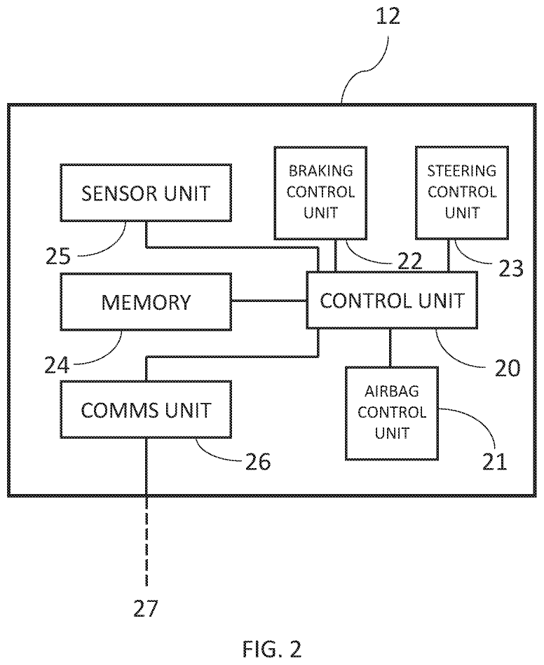

FIG. 2 shows an example of a vehicle apparatus 12 located within a vehicle 10 according to some embodiments of the present disclosure. According to FIG. 2, the vehicle apparatus 12 comprises a control unit 20 (or control circuitry 20) which is configured to receive information from and/or provide information to a communication unit 26 (or communication circuitry 26), a sensor unit 25 (or sensor circuitry 25), and a memory 24. The communication unit 26 may be communicably connected 27 to other units within the vehicle 10. It will be appreciated that FIG. 2 is an exemplary embodiment of the present disclosure and not all of the units are required to achieve the effects of the invention. The vehicle apparatus 12 may be a single unit as shown in FIGS. 1 and 2. In some embodiments of the present disclosure, each of the units within the vehicle apparatus 12 may be distributed throughout the vehicle. In some embodiments of the present disclosure, units of the vehicle apparatus 12 may be communicably connected in ways other than those shown in FIG. 2, i.e. through control unit 20. For example, there may be direct communications links between sensor unit 25, memory 24 and communications unit 26. It will be further appreciated by those skilled in the art that the vehicle apparatus 12 or indeed vehicle 10 may not comprise all units shown in the vehicle apparatus 12 of FIG. 2, or may comprise a number of other units configured to perform various similar or unrelated functions. In general, the term vehicle apparatus 12 is used to refer to the one or more of the units in FIG. 2, through the vehicle apparatus 12 may be understood to be a control unit itself, with control unit 20 specifically being a control unit for the purposes of controlling operation of the vehicle 10 in response to detecting a hazard, a risk of a collision, or that a collision is unavoidable, etc. The control unit 20 may be in communication with, and may control operation of, one or more sub-control units, including but not limited to airbag control unit 21 (or airbag control circuitry 21), braking control unit 22 (or braking control circuitry 22), and steering control unit 23 (or steering control circuitry 23). Such sub-control units 21, 22, 23 may be configured to perform certain functions, described in further detail below, when an unavoidable collision (or indeed, a potentially avoidable collision) is deemed to be about to occur by the control unit 20 in accordance with information received from sensor unit 25.

The sensor unit 25 is configured to detect information regarding a region surrounding the vehicle or operation of the vehicle itself, and either be, or be responsible for, the sensors 14 shown in FIG. 1. In some embodiments of the present disclosure, the sensor unit 25 may comprise one or more cameras, one or more time of flight sensors, and/or one or more distance sensors. The one or more cameras may be configured to capture one or more images or moving images of the region surrounding the vehicle as image information. In some embodiments, cameras may derive data from images, such as feature data pertaining to for example any one or more of objects, colours, lighting, edges, motion in images and store and process that data. In some embodiments this may improve processing speed. The one or more time of flight sensors may be configured to measure the distance between the time of flight sensors and objects/subjects in the area surrounding the vehicle, and with which the vehicle 10 may potentially collide. The one or more distance sensors may be Light Detection and Ranging (LIDAR) sensors. In some embodiments of the present disclosure, the sensor unit 25 and/or sensors 14 may comprise or be a plurality of cameras mounted on the vehicle to cover a 360 or near-360 degree perspective of the surrounding region. The one or more cameras may provide the image information to the control unit 20 as sensor information. The one or more distance sensors are configured to detect a distance of objects in the surrounding region from the vehicle as distance information. Examples of objects in the surrounding region are pedestrians, street furniture, animals, cyclists, other vehicles or the like. The LIDAR sensors provide the distance information to the control unit 20 as sensor information. In some embodiments of the present disclosure, the sensor information which is provided from the sensor unit 25 to the control unit 20 comprises both the one or more images of the surrounding region provided by the one or more cameras (image information) and distances between objects in the surrounding region and the vehicle provided by the one or more LIDAR sensors (distance information). In some embodiments of the present disclosure, the distance sensors are not present and a distance between the vehicle and objects in the surrounding region may be determined using a Global Navigation Satellite System (GNSS) technology as would be well understood by those skilled in the art. In some embodiments of the present disclosure, the sensor unit 25 includes means to detect one or more of a speed, direction and acceleration of the vehicle. The sensor unit 25 may provide one or more of the speed, direction and acceleration of the vehicle to the control unit 20 as sensor information. For example, the sensor unit 25 may include an accelerometer.

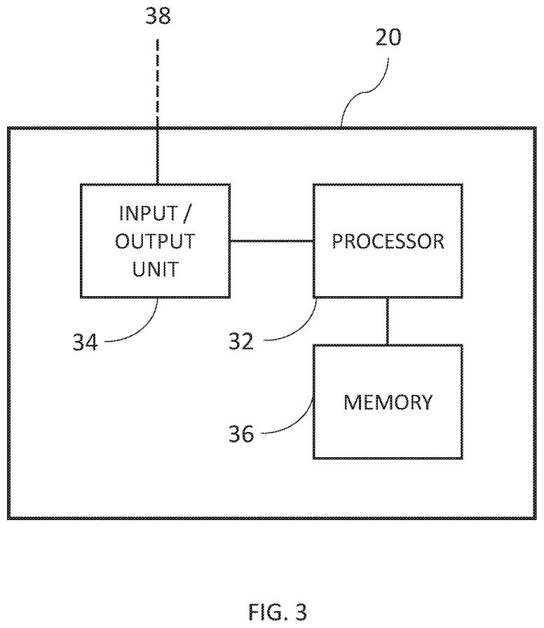

FIG. 3 shows an example of a control unit 20 in accordance with embodiments of the present technique. Control unit 20 may be the same as the control unit 20 shown in FIG. 2, or may be more broadly equivalent to vehicle apparatus 12 as shown in FIGS. 1 and 2. Control unit 20 may comprise an input/output or communications unit 34 configured to receive and transmit signals 38 to and from units or systems outside of the control unit 20. The control unit 20 also comprises a memory 36 and a processor 32 configured to perform operations stored in memory 36. Those skilled in the art would appreciate that in accordance with some embodiments of the present disclosure, the control unit 20 may not comprise its own memory 36 and may instead receive and store data in memory unit 24 of the vehicle apparatus 12.

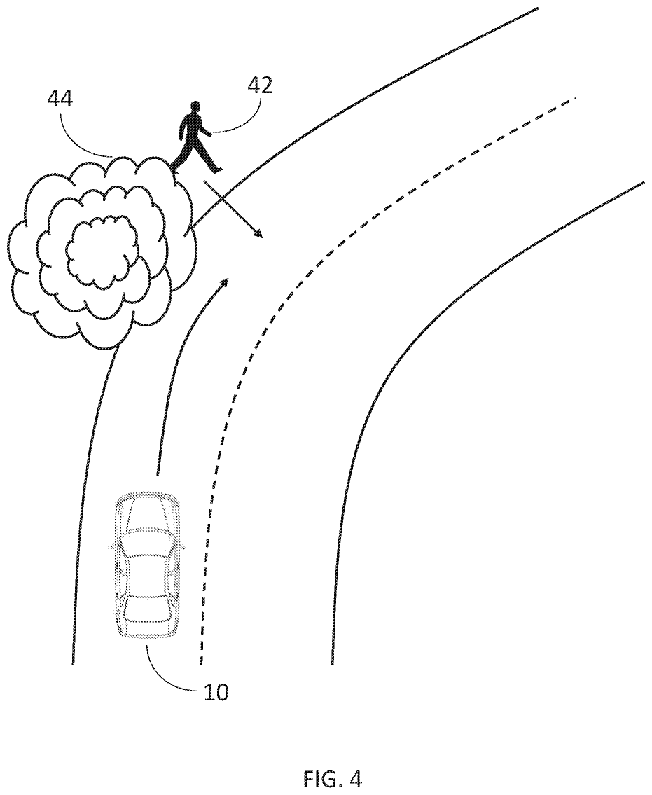

FIG. 4 shows an example of how an unavoidable collision between vehicle 10 and pedestrian 42 (also termed herein as “vulnerable road user” and/or “vulnerable subject” and may also be referred to as any of a “non-motorised road user”, “non-motorised subject”, “non-vehicular road user” or “non-vehicular subject”) may occur. Pedestrian 42 may be obscured from view of the sensors 14 of the vehicle 10 by an obstruction, such as tree 44, and the vehicle 10 may therefore be unaware of the potential risk of a collision with the pedestrian 42 until such a point at which it is too late to avoid the collision. A “vulnerable road user” is a term that would be well understood by those skilled in the art, for example in the United Kingdom [1] and in the European Union [2]. This term is used herein along with “vulnerable subject” to refer to non-vehicular or non-motorised road users, lighter road users, animals and the like, which may be at risk of harm in a collision with a vehicle.

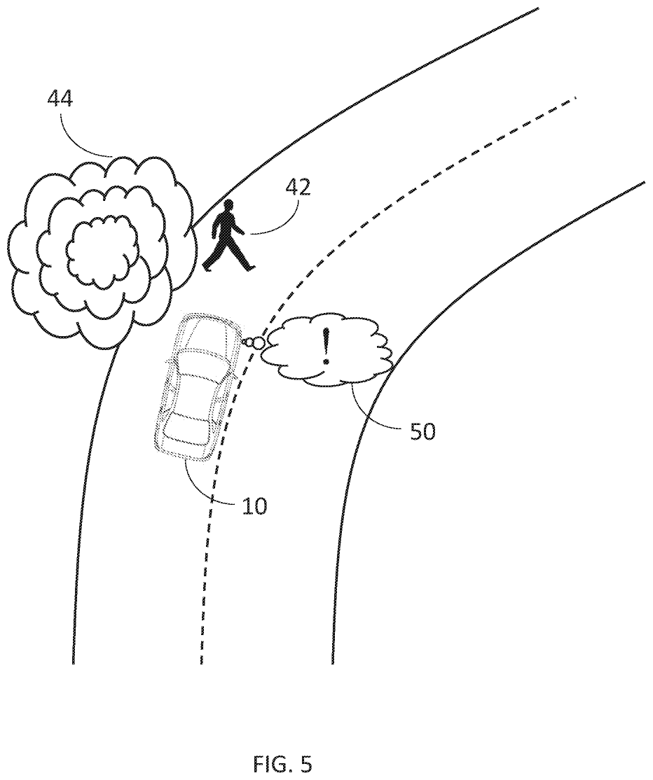

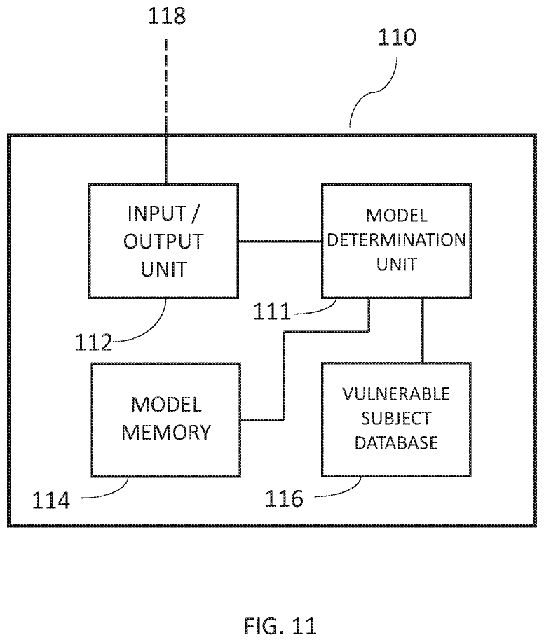

FIG. 5 shows an example of how a vehicle 10 may determine that an unavoidable collision with a pedestrian 42 is going to take place. The control unit 20 of the vehicle 10 determines, in combination with the one or more sensors 14 of the vehicle 10, that a vulnerable subject 42 (i.e. the pedestrian 42) is travelling on a path which intersects with a path on which the vehicle 10 is travelling, and may subsequently determine 50 that a collision between the vehicle 10 and the vulnerable subject is likely. The control unit 20 may make such a determination based on comparing a likelihood of the collision occurring with a predefined likelihood threshold stored in memory 25 or elsewise known or accessible to the control unit 20, or the control unit 20 may simply determine there is any amount of risk of a collision with the vulnerable subject 42 without any emergency actions being performed by the vehicle 10. The control unit 20 may determine that the collision is unavoidable. The control unit 20 may then be configured to predict a force of the collision, and with it, may be able to predict forces that may be imparted to the pedestrian 42, and a subsequent momentum of the pedestrian 42, as a result of the collision. The control unit 20 may then be configured to select, in accordance with the predicted force of the collision, one of a plurality of models each defining an operation of the vehicle 10 in response to determining that the vehicle 10 is unable to avoid the collision, wherein the selected model is selected on the basis that the control unit 20 determines it to result in a least amount of injury for the vulnerable subject 42 from among the plurality of models, and/or indeed least amount of damage to the vehicle 10 and/or least amount of injury to the occupants of the vehicle 10. The model may be selected on the basis of the path of the vehicle 10 and/or the path of the vulnerable subject 42 as well as the predicted force of impact of the collision, and/or on the basis of the speed of the vehicle 10 and/or the speed of the vulnerable subject 42. The model may be further selected on the basis of a predicted (i.e. by the control unit 20) post-collision velocity of the vulnerable subject 42, both in terms of the speed with which they may hit the ground or other vehicles or objects in the vicinity of the vehicle 10, roll over or be dragged under the vehicle, and in terms of the direction in which the vulnerable subject 42 may be thrusted, particularly if a model risks that direction being one towards oncoming traffic. Furthermore, the model may be selected on the basis of the type of the vehicle 10 and/or on the vulnerable subject 42 themselves. For example, more weight may be given to the protection of the driver of a motorbike than would for the driver of a lorry, where the model may be entirely or almost entirely selected with a view to ensuring a least amount of injury for the vulnerable subject 42. FIG. 11, which is described in detail below, illustrates how a model may be selected.

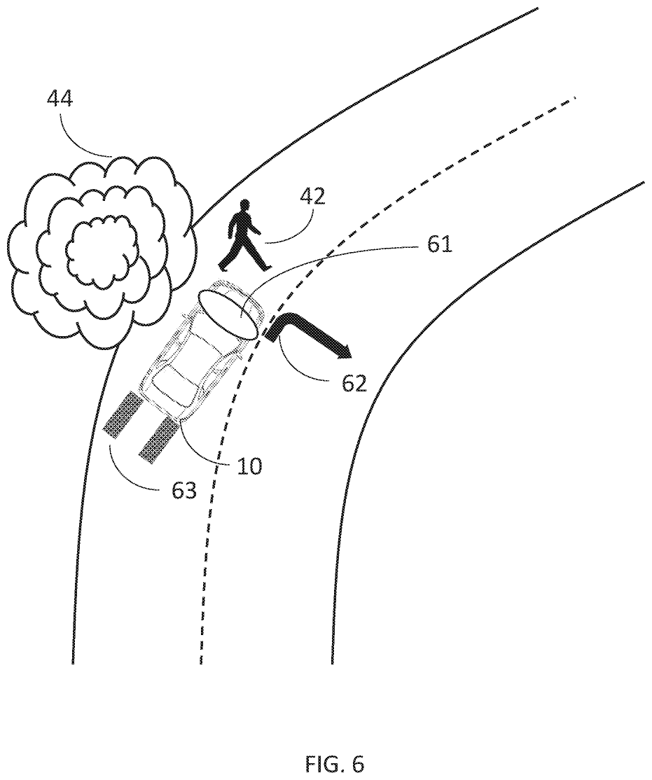

FIG. 6 shows an example of how a vehicle 10 may react to determining that an unavoidable collision with a pedestrian 42 is going to take place. The control unit 20 of the vehicle 10 controls one or more functions of the vehicle 10 in accordance with the selected model. Such controlling of one or more functions by the control unit 20 may comprise controlling operation of one or more of airbag control unit 21, braking control unit 22, and steering control unit 23. Here, the one or more functions may include — but are not limited to—an inflation 61 of one or more external airbags 16 of the vehicle 10 (e.g. controlled by the airbag control unit 21), a braking function 63 of the vehicle 10, the braking function 63 controlled by braking control unit 22 of the vehicle 10 so as to reduce a force of the collision, and/or a steering function 62 of the vehicle 10, the steering function 62 being controlled by steering control unit 23 of the vehicle 10 so as to control an impact location on the vehicle 10. Of course, as would be appreciated by those skilled in the art, the vehicle 10 may perform other operations than deploying 61 external airbags 16, braking 63 or swerving 62. For example, where it is detected by the vehicle 10 that the vulnerable subject 42 (or indeed in such a case, another vehicle) is moving along a path substantially perpendicular to the vehicle 10 and at a high speed (particularly when travelling at a higher speed than the vehicle) and the collision is likely to be at the side of the vehicle 10, the control unit 20 may control an acceleration of the vehicle 10 to be increased (or indeed control the braking control unit 22 to control the braking function 63), such that the vulnerable subject 42 (or other vehicle) collides with an area at the side of the vehicle 10 where protection provided by and/or inflation of external airbags 16 located at the side of the vehicle 10 is greatest.

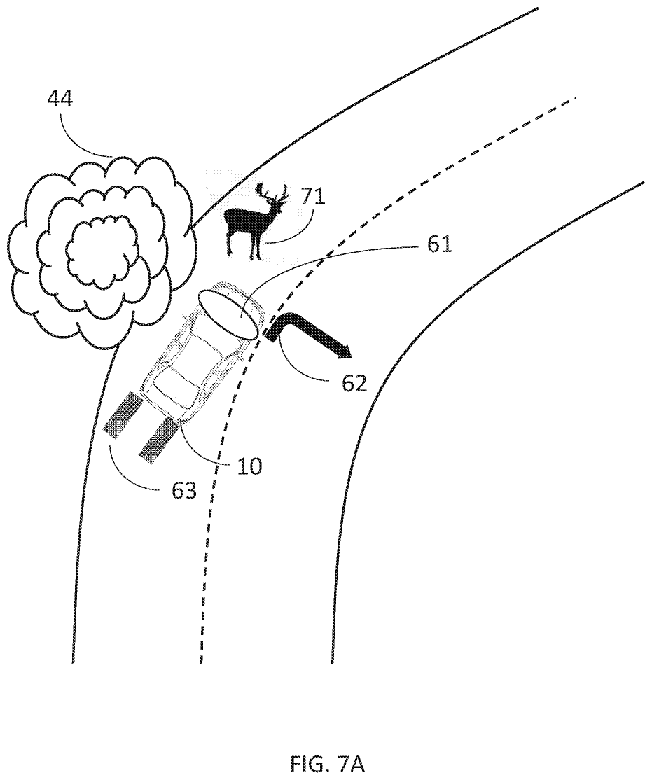

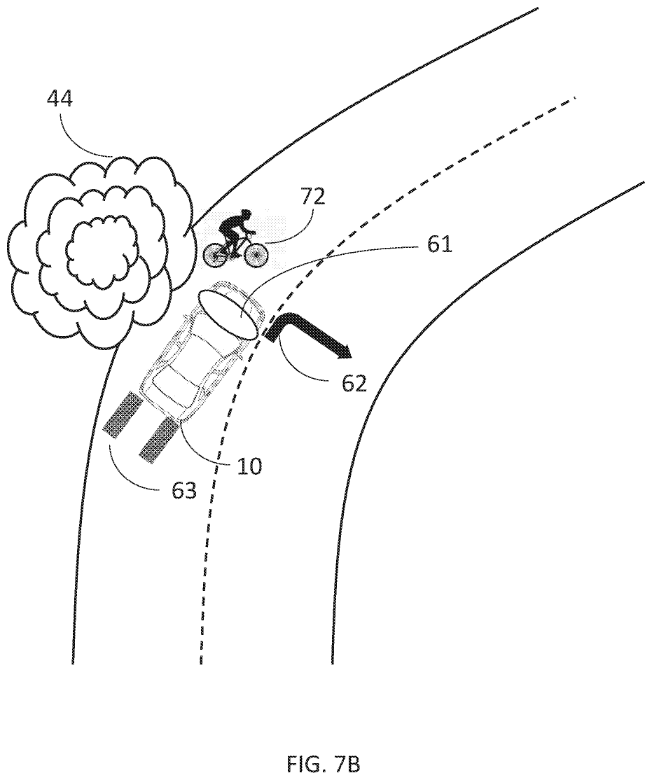

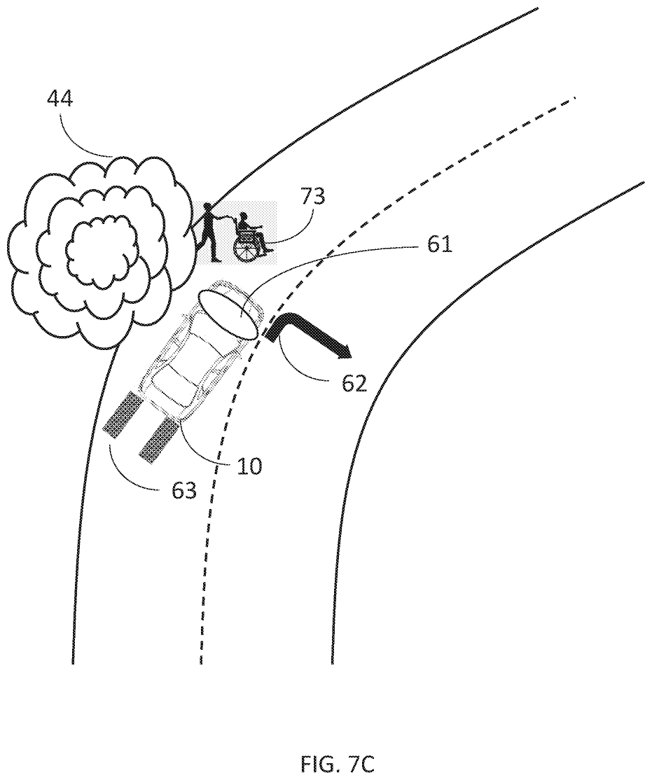

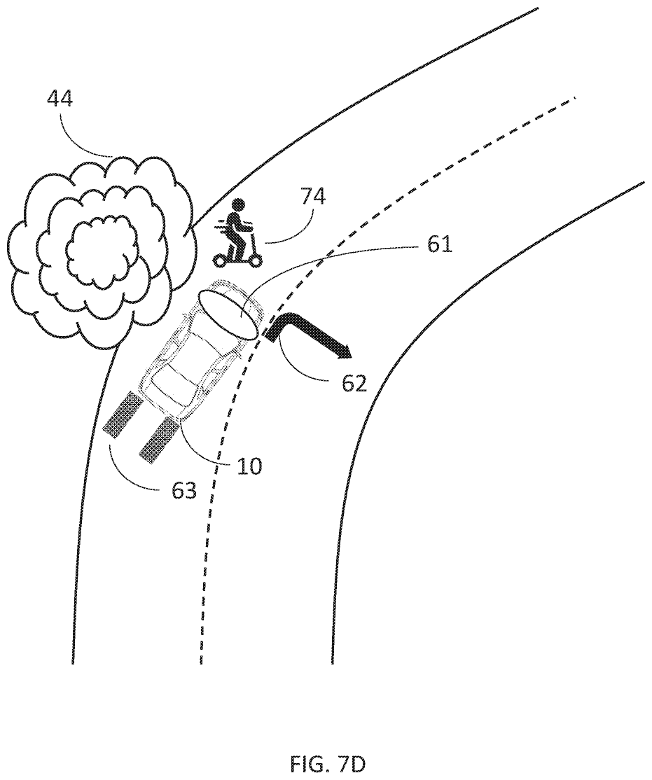

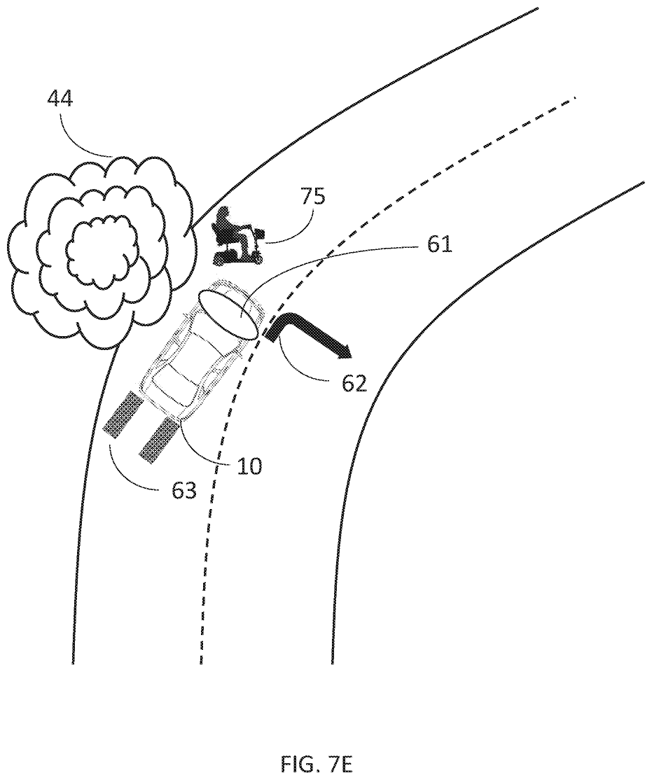

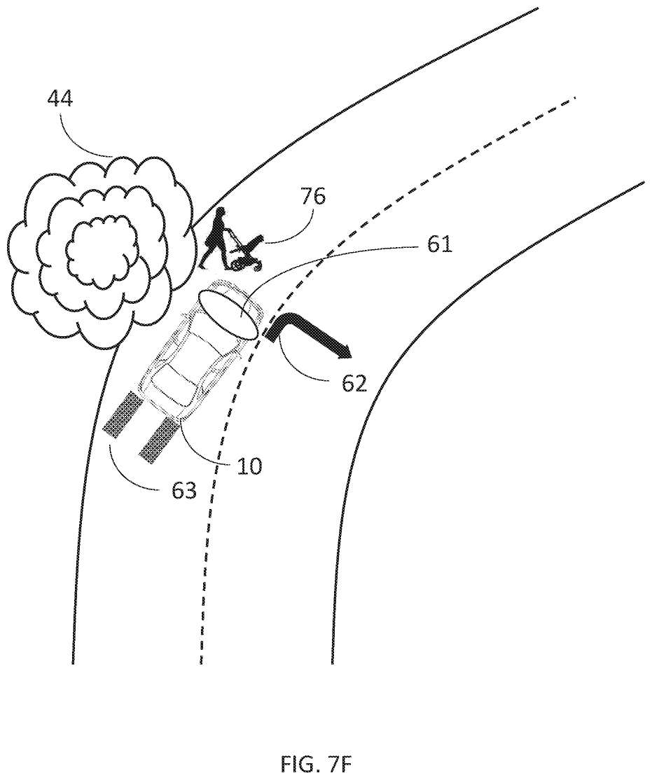

It should be appreciated by those skilled in the art that while FIGS. 4, 5 and 6 each show a pedestrian 42 on foot, pedestrian 42 could instead be any conceivable vulnerable subject, including but not limited to a person on foot, a cyclist, a wheelchair user and/or a person pushing the wheelchair, a young child in a pushchair being pushed by another person, a person pushing a handcart or the like, a person operating any of a skateboard, roller skates or a scooter, a motorcycle, an autonomous robot (e.g. a delivery robot) an animal (such as a wild deer, cows, horses, or the like, or a pet such as a cat or the like), a horse and rider, or indeed a person operating a motorised wheelchair, mobility scooter, electric scooter, electric bicycle, hoverboard, or the like. As mentioned above, the model may be selected on the basis of the vulnerable subject 42. That is, more weight may be given to the prevention of injury to a vulnerable subject 42 when that subject is a person rather than a robot or an animal FIG. 7A shows an example in which the control unit 20 of the vehicle 10 controls the one or more functions of the vehicle 10 in accordance with the selected model selected on the basis that the control unit 20 determines it to result in a least amount of injury for an animal 71 (for example, as shown in FIG. 7A, a deer) from among the plurality of models. Particularly, where the animal 71 is a large animal, the selected model may be selected on the basis that it causes the least amount of damage to the vehicle 10. Alternatively, where the animal 71 particularly is a small animal such as a pet, or a bird, or the like, the control unit 20 may determine in combination with the sensors 14 that, while the convergence of the vehicle 10 and the animal 71 is unavoidable, the size of the animal 71 may mean that the collision itself is potentially avoidable by the vehicle 10 passing over the animal 71 in a way that would not be possible with pedestrian 42 or a larger animal 71 such as the deer shown in FIG. 7A. Here, the control unit 20 may be configured to control operation of the steering control unit 23 and/or the braking control unit 22 so as to ensure that the “collision” with the animal 71 occurs at a point of the vehicle 10 other than the wheels, to give the animal 71 a chance to escape unharmed as the vehicle 10 passes over them, rather than swerving more extremely in an attempt to avoid an unavoidable collision and causing injury or death to the animal 71 by striking and/or running over it with the wheels of the vehicle 10.

FIGS. 7B to 7E are equivalent to FIGS. 6 and 7A, but illustrate different examples of a vulnerable subject than the pedestrian 42 shown in FIG. 6 and the animal 71 shown in FIG. 7A. FIG. 7B illustrates an example of operation of a vehicle 10 where functions are performed to mitigate a collision between the vehicle 10 and a cyclist 72 in accordance with the selected model, while FIG. 7C illustrates an example of operation of a vehicle 10 where functions are performed to mitigate a collision between the vehicle 10 and a wheelchair user 73 in accordance with the selected model. FIGS. 7D, 7E and 7F again show equivalent example operations of a vehicle 10 where functions are performed to mitigate a collision between the vehicle 10 and, respectively, a person operating a scooter 74, a user of a mobility scooter 75, and a pushchair 76 (and the person pushing the pushchair 76). It will be appreciated by those skilled in the art that the examples of FIGS. 6 and 7A to 7F are only examples, and that the vulnerable subject as described herein may be a subject other than one illustrated in any of FIG. 6 or 7A to 7F.

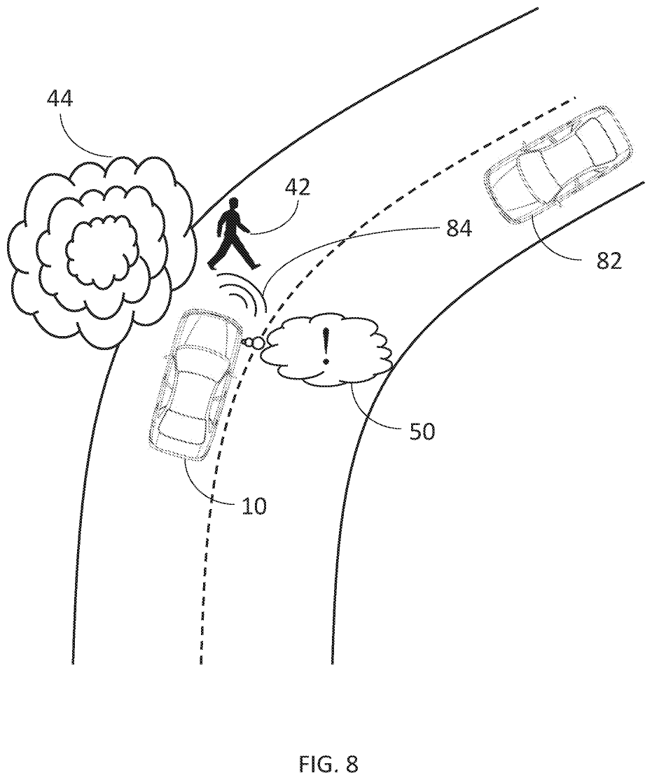

In some embodiments of the present disclosure, it may be the case that the vehicle 10 determines that the best case scenario/least amount of injury for the vulnerable subject 42 is one which avoids them being thrust into the path of other vehicles, as has been described above. However, it would be appreciated that, with respect to at least one of the pre-collision velocities of the vehicle 10 and the vulnerable subject 42, the amount of time between detection of the vulnerable subject 42 by the vehicle 10 and the collision itself (particularly if there are lots of obstructions such as tree 44 between the vehicle 10 and the vulnerable subject 42), the position of the vehicle 10 on the road, or to the amount of traffic on the road, it may not always be possible to avoid the vulnerable subject 42 being thrust into the path of oncoming traffic, or at the least being thrust to a position on or by the road where the vulnerable subject 42 is at some risk of being involved in a secondary collision with another vehicle. FIG. 8 illustrates an example operation of the vehicle 10 in such cases in accordance with embodiments of the present technique. Here, the control unit 20 of the vehicle 10 determines, in combination with the one or more sensors 14 of the vehicle 10, that a vulnerable subject 42 (i.e. the pedestrian 42) is travelling on a path which intersects with a path on which the vehicle 10 is travelling, and may subsequently determine 50 that the vehicle 10 is unable to avoid a collision with the vulnerable subject. The control unit 20 may then, as described above with respect to the example of FIG. 4, be configured to predict a force of the collision, and with it, may be able to predict how, in terms of force and momentum for example, the pedestrian 42 may be impacted by the collision. The control unit 20 may then be configured to select, in accordance with the predicted force of the collision, one of a plurality of models each defining an operation of the vehicle 10 in response to determining that the vehicle 10 is unable to avoid the collision, wherein the selected model is selected on the basis that the control unit 20 determines it to result in a least amount of injury for the vulnerable subject 42 from among the plurality of models, and/or indeed least amount of damage to the vehicle 10 and/or least amount of injury to the occupants of the vehicle 10. In this case, none of the plurality of models that the control unit 20 is able to select result in the vulnerable subject 42 being thrust into a safe location. That is, the control unit 20 may determine that the selected model (or indeed, any of the possible models it could select) is likely to result in the vulnerable subject 42 being thrown into the path of oncoming traffic, such as that of second vehicle 82. Here, the focus of the control unit 20 may change to ensuring that a secondary collision does not occur, and so the control unit 20 may control the communications unit 26 of the vehicle apparatus 12 to transmit a warning signal 84 receivable by the second vehicle 82, the warning signal 84 notifying the second vehicle 82 of the collision and the risk that that the collision could cause the vulnerable subject 42 to be thrusted into the path of the second vehicle 82.

FIG. 9 shows a first example configuration of external airbags 16 on a vehicle 10. The vehicle 10 may comprise a first external airbag 92 on the front, which deploys over the windscreen and bonnet 94 from, for example, the base of the windscreen or at the top of the bonnet 94 itself. The first external airbag 92 may be particularly important for softening the impact of vulnerable subjects 42 which are struck by the vehicle 10, typically full on by the front of the vehicle 10, and may be thrown over the bonnet 94 of the vehicle 10. The vehicle 10 may comprise second external airbags 96 on the corners of the vehicle 10, which may be particularly important for softening the impact of vulnerable subjects 42 which are struck by the vehicle 10 on the corners, typically through operation of the steering control unit 23 of the vehicle apparatus 12 of the vehicle 10 as the vehicle 10 swerves to avoid a full front-on collision with the vulnerable subject 42. Alternatively, in at least some embodiments of the present technique, where the first external airbag 92 may for example be a pedestrian airbag, while second external airbags 96 are designed to cushion impacts between the vehicle 10 and another vehicle, the control unit 20 may determine that a front-on collision between the vehicle 10 and the vulnerable subject 42 is better, as the first external airbag 92 provides a better level of protection, and thus results in a lower amount of injury or a higher life-saving likelihood, for the vulnerable subject 42 than the second external airbags 96.

The vehicle 10 may comprise third external airbags 98 located at the side of the vehicle 10, which may be particularly important, as described above with reference to FIG. 6, when the vulnerable subject 42 (or another vehicle) is moving along a path substantially perpendicular and at a high speed (particularly when travelling at a higher speed than the vehicle) and the collision is likely to be at the side of the vehicle 10. Here, as described above with reference to FIG. 6, the control unit 20 may additionally control the braking function 63 or may control an acceleration of the vehicle 10 to be increased, such that the vulnerable subject 42 (or other vehicle) collides with an area at the side of the vehicle 10 where protection provided by and/or inflation of the third external airbags 98 located at the side of the vehicle 10 is greatest. Of course, those skilled in the art would appreciate that the number and placement of the external airbags 92, 96, 98 on vehicle 10 as shown in the example of FIG. 9 (and that shown in the example of FIG. 10 which is described in further detail below) is only one example of how external airbags 16 could be configured on a vehicle 10.

In general terms, the control unit 20 may choose, in accordance with the selected model, one or more of the external airbags 92, 96, 98 which provides a best outcome and/or least amount of injury and/or or a highest life-saving likelihood for the vulnerable subject 42, and control at least one of the steering function 62, braking function 63 or acceleration function in order to position the vehicle 10 such that the impact between the vehicle 10 and the vulnerable subject 42 is with the one or more of the external airbags 92, 96, 98 chosen by the control unit 20, or with a specific part or area of the one or more of the external airbags 92, 96, 98 chosen by the control unit 20. Depending on what the control unit 20 predicts the post-collision velocity of the vulnerable subject 42 to be, the control unit 20 may be configured to control the airbag control unit 21 to control inflation 61 of two or more of the external airbags 92, 96, 98 in turn, with the airbag control unit 21 inflating 61 at least a first of the external airbags 92, 96, 98 and inflating at least a second of the external airbag 92, 96, 98 a predetermined time after the first of the external airbags 92, 96, 98. For example, where the control unit 20 determines in accordance with the selected model that the vulnerable subject 42 may be further thrown against the vehicle 10 after the initial collision, a second of the external airbags 92 96, 98 (which may be a second airbag located close to the first external airbag 92 on the front of the vehicle 10 where both are pedestrian airbags) in order to protect the head of the vulnerable subject 42 where, for example, the first collision is likely to be between the torso of the vulnerable subject 42 and the first external airbag 92 and that this is likely to throw the head of the vulnerable subject 42 forward. Similarly, the second of the external airbags 92, 96, 98 could be controlled to deploy in the event of a side impact which might risk the vulnerable subject 42 from being caught and dragged along by the vehicle 10, for example, by loose clothing worn by the vulnerable subject 42.

Furthermore, even in the event that the vehicle 10 is stationary and/or the engine is off, the airbag control unit 21 may still be configured to inflate one or more of the external airbags 92, 96, 98 in response to detecting a potentially unavoidable collision. For example, if a cyclist or other vulnerable road user (or, indeed, a second vehicle passing close by the vehicle 10) is passing the vehicle 10 as the driver or other occupant of the vehicle 10 opens a door of the vehicle 10 or starts to open the door, one or more external airbags at the side of the vehicle 10 or located on or around the door itself may be inflated by the airbag control unit 21 so as to cushion an impact between the cyclist or other vulnerable road user and the open or partially open door. Such an event may also comprise the control unit 20 controlling a warning signal to be communicated to the driver or other occupant(s) of the vehicle 10 that a nearby cyclist or other vulnerable road user (or, indeed, a second vehicle passing close by the vehicle 10) has been detected and the driver/occupant should not continue the opening of the door until it is safe to do so. Of course, the control unit 20 of the vehicle 10 cannot be sure what the driver/occupant is going to do, and so may control inflation of the external airbag(s) in combination with transmitting the warning signal, so as to ensure that any potential injury caused to the cyclist or other vulnerable road user is minimised.

The control unit 20 may determine in accordance with the selected model that the vulnerable subject 20 may sequentially or simultaneously collide with areas of the vehicle from where impact can be softened by different ones of the one or more external airbags 92, 96, 98. In such a case, the control unit 20 and airbag control unit 21 control inflation of more than one of the external airbags 92, 96, 98. In at least some cases, the control unit 20 and airbag control unit 21 may control inflation of the two or more of the external airbags 92, 96, 98 differently; that is at least one of the external airbags 92, 96, 98 may be inflated more fully than at least one other of the external airbags 92, 96, 98. This is described in further detail below with respect to the example illustrated by FIG. 10.

FIG. 10 shows a second example configuration of external airbags 16 on a vehicle 10, where again the vehicle 10 may comprise first external airbag 92 on the front of the vehicle, second external airbags 96 on the corners of the vehicle 10, and third external airbags 98 along the side of the vehicle 10. In the example of FIG. 10, the first external airbag 92 (and/or indeed, though not shown in FIG. 10, second or third external airbags 96, 98) may comprise a number of sections or pockets A to E which may inflated in accordance with different amounts (i.e. non-uniformly) depending on the model of operation selected by the control unit 20. For example, like the embodiments described above with respect to FIG. 9, a first pocket or pockets of first external airbag 92 (e.g. pockets A and C) may be inflated first, to cushion the vulnerable subject 42 during the first collision, while a second pocket or pockets (e.g. pockets B and E) may be inflated shortly afterwards, for example to cushion the impact between the vehicle 10 and the head of the vulnerable subject 42 during a second collision. In some embodiments of the present disclosure, pockets may have their own inflation mechanisms or may be configured with passive or actively controlled channels through which they are inflated by a common inflation mechanism to inflate pockets differently.

In some embodiments of the present disclosure, the pockets A to E of first external airbag 92 (or of external airbags 96, 98) may be inflated differently to ensure that the post-collision trajectory of the vulnerable subject 42 is not upwards (i.e. the pedestrian or animal is not thrown into the air following the collision) or not towards oncoming traffic.

FIG. 11 shows an example of a model selection unit 110 (or model selection circuitry 110) in accordance with embodiments of the present disclosure. Such circuitry may in some embodiments form part of the control unit 20 or vehicle apparatus 12, or alternatively may be implemented separately. The example model selection unit 110 as shown in FIG. 11 comprises an input/output unit 112 (or input/output circuitry 112) configured to receive as input(s) 118 data from various sensors 14 regarding both the vehicle 12 and the vulnerable subject 42, and to transmit as output(s) 118 the selected model after it has been selected. The example model selection unit 110 as shown in FIG. 11 also comprises a model determination unit 111, connected to the input/output unit 112, and configured to determine which model should be selected from a plurality of possible models based on the received inputs 118. Such plurality of possible models may be stored in a model memory 114 or the like, while an in-vehicle vulnerable subject database 116 may comprise sets of pairs of vulnerable subjects and models, further coupled with various conditions or parameters defining a most likely model to be selected in any scenario. This vulnerable subject database 116 may be updateable, as the vehicle 10 learns more about collisions with various different vulnerable subjects 42 (downloadable or receivable via any suitable wired or wireless technology) that may have been experienced by other vehicles similar to vehicle 10. The information stored in both memory 114 and database 116 may be regionalised depending on where vehicle 12 is sold; for example, with respect to different traffic laws in those regions or different types of vulnerable road subject 42 (e.g. animals) found there. Those skilled in the art would appreciate that the model selection unit 110 as shown in FIG. 11 is only an example, and that other such model selection units or circuitry in accordance with embodiments of the present technique, for example, may not comprise one of the memory 114 and vulnerable subject database 116, or may only retrieve full models from memory 114 or vulnerable subject database 116, or may only calculate models on an ad-hoc basis from certain base models dependent on the information received from input/output unit 112 (or similar).

In embodiments of the present disclosure, a model is a software code representation of inputs and corresponding expected results. It may include conditions or parameters which are input 118 to it from other sensors 14 such as ambient temperature, ambient humidity, road surface texture, road surface temperature, road surface humidity, tyre inflation, tyre wear, grade of tyre, brake condition, and GNSS sensor and location information. Such conditions may apply differently to each wheel of the vehicle 10. Conditions or parameters may also be input for the detected vulnerable subject 42, such as expected weight which may be derived from a relative or actual size estimate produced from data from the sensors. Orientation or movement direction of the vulnerable subject 42 way also be inputs to the model and processed to determine an expected least amount of injury. The location or position (i.e. geographical position) information of the vehicle 10 may be determined by any of the signals from the GNSS sensor, location information, or hardcoded location information known by or accessible to the model selection unit 110 based on which markets/territories the vehicle 10 is manufactured and/or to be sold in. The location or position information of the vehicle 10 may be used by the model determination unit 111 to determine or calculate the candidate model it selects to use in the collision mitigation. For example, in a country where animals such as elephants are not found in the wild, if information from other sensors indicates an elephant is in the road, the model determination unit 111 is likely to give less weight to this sensor information when determining and selecting the model for collision avoidance, as it knows that an elephant being in the road is statistically improbable.

As described above, models may be pre-stored in electronic memory 114, while additionally and/or alternatively, models may be calculated from certain base models by conditions or by combining two or mode base models. These base models may also or equivalently be stored in the model memory 114, or may instead be retrieved from vulnerable subject database 116 on the basis of the identified vulnerable subject 42. Inputs 118 may for example be inflation of airbags 92, 96, 98, change in steering direction, change in power distribution to the wheels (i.e. braking or accelerating).

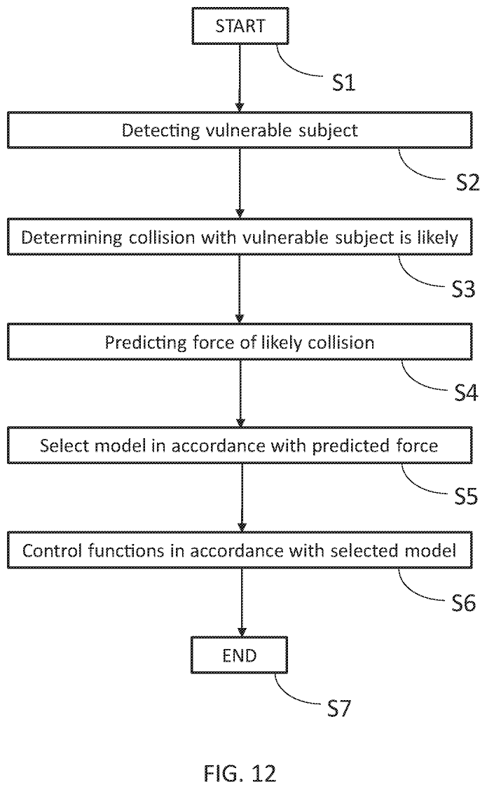

FIG. 12 shows a method of operating a vehicle 10 in accordance with embodiments of the present disclosure. The method starts in step S1. In step S2, the method comprises determining, by a control unit 20 of the vehicle 10 in combination with one or more sensors 14 of the vehicle 10, that a vulnerable subject 42 is travelling on a path which intersects with a path on which the vehicle 10 is travelling. In step S3, the process includes determining, by the control unit 20, that the vehicle 10 is unable to avoid a collision with the vulnerable subject 42. In step S4, the method includes predicting, by the control unit 20, a force of the collision, and in step S5, the process comprises selecting, by the control unit 20 in accordance with the predicted force of the collision, one of a plurality of models each defining an operation of the vehicle 10 in response to determining that the vehicle 10 is unable to avoid the collision, wherein the selected model is selected on the basis that the control unit 20 determines it to result in a least amount of injury for the vulnerable subject 42 from among the plurality of models. In step S6, the method comprises controlling, by the control unit 20, one or more functions 61, 62, 63 of the vehicle 10 in accordance with the selected model. The process ends in step S7.

Those skilled in the art would appreciate that the methods shown by FIG. 12 may be adapted in accordance with embodiments of the present technique. For example, other preliminary, intermediate, or subsequent steps as described herein may be included in the method, or the steps may be performed in any logical order. Though embodiments of the present technique have been described largely by way of the example systems shown by, and described with respect to, FIGS. 1 to 11, it would be clear to those skilled in the art that they could be equally applied to other systems to those described herein. Furthermore, to the extent that the various arrangements described herein are described individually, these can be combined with any other arrangement described herein providing the two do not contradict one another.

Those skilled in the art would further appreciate that such apparatus and systems as herein defined may be further defined in accordance with the various arrangements and embodiments discussed in the preceding paragraphs. It would be further appreciated by those skilled in the art that such apparatus, units, and devices as herein defined and described may form part of systems other than those defined by the present disclosure.

The following numbered paragraphs provide further example aspects and features of the present disclosure:

Paragraph 1. A method of operating a vehicle, comprising
determining, by control circuitry of the vehicle in combination with one or more sensors of the vehicle, that a vulnerable subject is travelling on a path which intersects with a path on which the vehicle is travelling,
determining, by the control circuitry, that a collision between the vehicle and the vulnerable subject is likely,
predicting, by the control circuitry, a force of the collision,
selecting, by the control circuitry in accordance with the predicted force of the collision, one of a plurality of models each defining an operation of the vehicle in response to determining that the vehicle is unable to avoid the collision, wherein the selected model is selected on the basis that the control unit determines it to result in a least amount of injury for the vulnerable subject from among the plurality of models, and
controlling, by the control circuitry, one or more functions of the vehicle in accordance with the selected model.

Paragraph 2. A method according to Paragraph 1, wherein the least amount of injury is determined by predicting a reduction to the predicted force of the collision to a second predicted force resulting from the selecting of the one of the plurality of models, the second predicted force being lower than the predicted force.

Paragraph 3. A method according to Paragraph 1 or Paragraph 2, wherein the one or more functions comprise an inflation of one or more external airbags of the vehicle.

Paragraph 4. A method according to Paragraph 3, wherein at least one of the external airbags is inflated non-uniformly in accordance with the selected model.

Paragraph 5. A method according to Paragraph 3 or Paragraph 4, wherein at least one of the external airbags is inflated more fully than at least one other of the external airbags.

Paragraph 6. A method according to Paragraph 5, wherein the method comprises inflating, by airbag control circuitry of the vehicle, at least a first of the external airbags and inflating at least a second of the external airbags a predetermined time after the first of the external airbags.

Paragraph 7. A method according to Paragraph 6, wherein the one or more functions additionally comprise a steering function of the vehicle, the steering function being controlled by steering control circuitry of the vehicle so as to control an impact location on the vehicle, at least one of the external airbags being located at the impact location on the vehicle.

Paragraph 8. A method according to any of Paragraphs 1 to 7, wherein the one or more functions comprise a braking function of the vehicle, the braking function controlled by braking control circuitry of the vehicle so as to reduce a force of the collision.

Paragraph 9. A method according to any of Paragraphs 1 to 8, wherein the one or more functions comprise a steering function of the vehicle, the steering function being controlled by steering control circuitry of the vehicle so as to control an impact location on the vehicle.

Paragraph 10. A method according to any of Paragraphs 1 to 9, wherein the method comprises selecting the model on the basis of the path of the vehicle and/or the path of the vulnerable subject.

Paragraph 11. A method according to any of Paragraphs 1 to 10, wherein the method comprises selecting the model on the basis of a speed of the vehicle and/or a speed of the vulnerable subject.

Paragraph 12. A method according to any of Paragraphs 1 to 11, wherein the method comprises selecting the model on the basis of a predicted post-collision velocity of the vulnerable subject.

Paragraph 13. A method according to any of Paragraphs 1 to 12, wherein the vulnerable subject is a pedestrian.

Paragraph 14. A method according to any of Paragraphs 1 to 13, wherein the vulnerable subject is a person operating at least one of a bicycle, a wheelchair, a skateboard, roller skates, a scooter.

Paragraph 15. A method according to any of Paragraphs 1 to 14, wherein the vulnerable subject is an animal.

Paragraph 16. A method according to Paragraph 15, wherein the method comprises detecting, by the control circuitry in combination with the one or more sensors, that the animal is smaller than a predetermined size and subsequently controlling the one or more functions in accordance with the selected model so as to avoid the collision occurring at a wheel area of the vehicle.

Paragraph 17. A method according to Paragraph 15 or Paragraph 16, wherein the method comprises selecting the model on the basis of the control circuitry determines it to result in a least amount of damage to the vehicle from among the plurality of models.

Paragraph 18. A method according to any of Paragraphs 1 to 17, wherein the method comprises selecting the model on the basis of the control circuitry determines it to result in a least amount of injury for one or more occupants of the vehicle from among the plurality of models

Paragraph 19. A method according to any of Paragraphs 1 to 18, wherein the method comprises
determining, by the control circuitry, that there is a risk that the collision could cause the vulnerable subject to be thrusted into a path of a second vehicle, and
transmitting, by communications circuitry of the vehicle, a warning signal receivable by the second vehicle, the warning signal notifying the second vehicle of the collision and the risk that that the collision could cause the vulnerable subject to be thrusted into the path of the second vehicle.

Paragraph 20. An apparatus for use in a vehicle, the apparatus comprising circuitry configured
to determine, in accordance with input signals received from one or more sensors, that a vulnerable subject is travelling on a path which intersects with a path on which the vehicle is travelling,
to determine that a collision between the vehicle and the vulnerable subject is likely,
to predict a force of the collision,
to select, in accordance with the predicted force of the collision, one of a plurality of models each defining an operation of the vehicle in response to determining that the vehicle is unable to avoid the collision, wherein the selected model is selected on the basis that the circuitry determines it to result in a least amount of injury for the vulnerable subject from among the plurality of models, and
to output to an interface control signals corresponding to one or more functions of the vehicle in accordance with the selected model.

Paragraph 21. An apparatus for use in a vehicle, the apparatus comprising
one or more sensors,
an interface, and
circuitry, wherein the circuitry is configured
to determine, in accordance with input signals received from the one or more sensors, that a vulnerable subject is travelling on a path which intersects with a path on which the vehicle is travelling,
to determine that a collision between the vehicle and the vulnerable subject is likely,
to predict a force of the collision,
to select, in accordance with the predicted force of the collision, one of a plurality of models each defining an operation of the vehicle in response to determining that the vehicle is unable to avoid the collision, wherein the selected model is selected on the basis that the circuitry determines it to result in a least amount of injury for the vulnerable subject from among the plurality of models, and
to output to the interface control signals corresponding to one or more functions of the vehicle in accordance with the selected model.

Paragraph 22. An apparatus for use in a vehicle, the apparatus comprising circuitry configured
one or more sensors,
an interface, and
control circuitry comprising processor circuitry and a memory comprising instructions which, when executed, cause the processor circuitry
to determine, in accordance with input signals received from the one or more sensors, that a vulnerable subject is travelling on a path which intersects with a path on which the vehicle is travelling,
to determine that a collision between the vehicle and the vulnerable subject is likely,
to predict a force of the collision,
to select, in accordance with the predicted force of the collision, one of a plurality of models each defining an operation of the vehicle in response to determining that the vehicle is unable to avoid the collision, wherein the selected model is selected on the basis that the circuitry determines it to result in a least amount of injury for the vulnerable subject from among the plurality of models, and
to output to the interface control signals corresponding to one or more functions of the vehicle in accordance with the selected model.

Paragraph 23. A computer program for causing a computer when executing the computer program to perform the method according to any of Paragraphs 1 to 19.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the disclosure.

### REFERENCES

[1] British Standards Institution, “CAV Vocabulary v2.0—Vulnerable road user (new)”, [Online], June 2020, Available from: https://www.bsigroup.com/en-GB/CAV/cav-vocabulary/vulnerable-road-user/
[2] European Commission, “Mobility and Transport—Intelligent transport systems—ITS & Vulnerable Road Users”, [Online], accessed July 2020, Available from: https://ec.europa.eu/transport/themes/its/road/action_plan/its_and_vulnerable_road_users_en

1. A method of operating a vehicle, comprising
determining, by control circuitry of the vehicle in combination with one or more sensors of the vehicle, that a vulnerable subject is travelling on a path which intersects with a path on which the vehicle is travelling,
determining, by the control circuitry, that a collision between the vehicle and the vulnerable subject is likely,
predicting, by the control circuitry, a force of the collision,
selecting, by the control circuitry in accordance with the predicted force of the collision, one of a plurality of models each defining an operation of the vehicle in response to determining that the vehicle is unable to avoid the collision, wherein the selected model is selected on the basis that the control unit determines it to result in a least amount of injury for the vulnerable subject from among the plurality of models, and
controlling, by the control circuitry, one or more functions of the vehicle in accordance with the selected model.

2. The method according to claim 1, wherein the least amount of injury is determined by predicting a reduction to the predicted force of the collision to a second predicted force resulting from the selecting of the one of the plurality of models, the second predicted force being lower than the predicted force.

3. The method according to claim 1, wherein the one or more functions comprise an inflation of one or more external airbags of the vehicle.

4. The method according to claim 3, wherein at least one of the external airbags is inflated non-uniformly in accordance with the selected model.

5. The method according to claim 3, wherein at least one of the external airbags is inflated more fully than at least one other of the external airbags.

6. The method according to claim 5, wherein the method comprises inflating, by airbag control circuitry of the vehicle, at least a first of the external airbags and inflating at least a second of the external airbags a predetermined time after the first of the external airbags.

7. The method according to claim 6, wherein the one or more functions additionally comprise a steering function of the vehicle, the steering function being controlled by steering control circuitry of the vehicle so as to control an impact location on the vehicle, at least one of the external airbags being located at the impact location on the vehicle.

8. The method according to claim 1, wherein the one or more functions comprise a braking function of the vehicle, the braking function controlled by braking control circuitry of the vehicle so as to reduce a force of the collision.

9. The method according to claim 1, wherein the one or more functions comprise a steering function of the vehicle, the steering function being controlled by steering control circuitry of the vehicle so as to control an impact location on the vehicle.

10. The method according to claim 1, wherein the method comprises selecting the model on the basis of the path of the vehicle and/or the path of the vulnerable subject.

11. The method according to claim 1, wherein the method comprises selecting the model on the basis of a speed of the vehicle and/or a speed of the vulnerable subject.

12. The method according to claim 1, wherein the method comprises selecting the model on the basis of a predicted post-collision velocity of the vulnerable subject.

13. The method according to claim 1, wherein the vulnerable subject is a pedestrian.

14. The method according to claim 1, wherein the vulnerable subject is a person operating at least one of a bicycle, a wheelchair, a skateboard, roller skates, a scooter.

15. (canceled)

16. The method according to claim 1, wherein the vulnerable subject is an animal and the method further comprises detecting, by the control circuitry in combination with the one or more sensors, that the animal is smaller than a predetermined size and subsequently controlling the one or more functions in accordance with the selected model so as to avoid the collision occurring at a wheel area of the vehicle.

17. The method according to claim 1, wherein the vulnerable subject is an animal and the method further comprises selecting the model on the basis of the control circuitry determines it to result in a least amount of damage to the vehicle from among the plurality of models.

18. The method according to claim 1, wherein the method comprises selecting the model on the basis of the control circuitry determines it to result in a least amount of injury for one or more occupants of the vehicle from among the plurality of models

19. The method according to claim 1, wherein the method comprises
determining, by the control circuitry, that there is a risk that the collision could cause the vulnerable subject to be thrusted into a path of a second vehicle, and
transmitting, by communications circuitry of the vehicle, a warning signal receivable by the second vehicle, the warning signal notifying the second vehicle of the collision and the risk that that the collision could cause the vulnerable subject to be thrusted into the path of the second vehicle.

20. An apparatus for use in a vehicle, the apparatus comprising circuitry configured
to determine, in accordance with input signals received from one or more sensors, that a vulnerable subject is travelling on a path which intersects with a path on which the vehicle is travelling,
to determine that a collision between the vehicle and the vulnerable subject is likely,
to predict a force of the collision,
to select, in accordance with the predicted force of the collision, one of a plurality of models each defining an operation of the vehicle in response to determining that the vehicle is unable to avoid the collision, wherein the selected model is selected on the basis that the circuitry determines it to result in a least amount of injury for the vulnerable subject from among the plurality of models, and
to output to an interface control signals corresponding to one or more functions of the vehicle in accordance with the selected model.

21. A non-transitory computer storage medium comprising computer code components that, when executed on a computer, cause the computer to perform the method according to claim 1.
